(19) United States
(12) Patent Application Publication
(10) Pub. No.: US 2004/0088181 A1
(43) Pub. Date: May 6, 2004

(54) Method and system for processing real estate transactions

(76) Inventors: Maurizio E. Romanin, Toronto (CA); Jian Zhang, Toronto (CA)

Correspondence Address: Mark B. Eisen, Dimock Stratton Clarizio LLP, 20 Queen Street West, Suite 3202, Box 102, Toronto, ON, M5H 3R3, CA

(21) Appl. No.: 10/385,737

(22) Filed: Mar. 12, 2003

(30) Foreign Application Priority Data
Nov. 4, 2002 (CA) 2,410,970

(51) Int. Cl. G06F 17/60

(52) U.S. Cl. 705/1

(57) ABSTRACT

A method and system for processing real estate transactions utilizing a remotely accessible site on a computer network for the transfer of data, information and documents between a purchaser and a vendor. In the preferred embodiment a web site provides a generally accessible portion which allows a purchaser to retrieve unrestricted documentation and/or data relating to the real estate transaction generally, and a plurality of password-protected portions each of which can be accessed only by a purchaser's lawyer or other representative having a preset password and allows same to retrieve purchaser-specific documentation relating particularly to the respective purchaser's unit. In the preferred embodiment the method and system of the invention also monitors when documents have been downloaded by each purchaser and flags the vendor's lawyer if any particular purchaser has not retrieved their documents by a preset time before the closing date.

### FIELD OF THE INVENTION

The present invention relates to a method and system for processing and sharing data in real estate transactions.

### BACKGROUND OF THE INVENTION

A typical real estate transaction involves the exchange of numerous closing documents between a purchaser's lawyer and a vendor's lawyer. In the case of a typical condominium transaction, many identical closing documents must be distributed to lawyers acting for the purchasers of individual units. In addition, certain closing documents specific to a particular unit must be distributed to the specific lawyer acting for the purchaser of that particular unit. The distribution of such closing documents often occurs both in conjunction with an interim closing allowing the purchaser to occupy the premises, as well as, at a later date, a final closing in which title is transferred to the purchaser, and in the case of a condominium usually occurs at generally the same time with scores or even hundreds of purchasers. In such a transaction, document management can be a significant burden on the vendor.

While the distribution of documents and data has to date involved paper documents transferred between parties by facsimile transmission, courier, or post, several problems arise from such a distribution system. Lawyers acting for either a purchaser or a vendor may take the position that they failed to receive a particular document or set of documents, and the other party to the transaction may be unable to dispute this claim. It has also been difficult to control the purchaser's access to closing documents in instances where a purchaser has failed to take certain actions by their respective deadlines, such as providing information requested by the vendor, directions regarding title, mortgagee approvals etc. In addition, such paper based systems have involved the distribution and management of a multitude of paper documents, with the resultant time and administrative costs associated therewith.

In any particular real estate transaction there may be many third parties who have a need to access documents and/or data relating to the transaction, for example title insurance providers, mortgagees, and so on. Moreover, in the process of developing documentation and entering or modifying data, errors can be introduced into the transaction documentation and data through successive re-entry of the same information.

Accordingly, it would be desirable to have a method and system which facilitates the isolation of data, the generation of documents and the transfer of data and documents between parties and their representatives in a real estate transaction; allows general documents to be generally retrieved while limiting the accessibility of purchaser-specific documentation to the party for whom the documentation is intended; allows third parties to access the documentation when authorized, without having to rely upon the parties to the transaction to provide the required documentation; maintains the integrity of information once it has been entered into a document; and allows a party to determine whether the other party to the transaction has received their transaction documentation. These advantages are particularly beneficial in the case of a multi-unit real estate transaction, such as a new condominium purchase.

The invention provides an interface through which purchasers can send data and instructions (e.g. directions regarding title) for collection and storage by a vendor and/or its representatives. Further, the invention provides a data resource which can be used to share information with suppliers of products and services for which the purchasers in a real estate transaction may have an interest or need, such as property insurance, home repair and maintenance services, etc.

### SUMMARY OF THE INVENTION

The invention provides a method and system for processing real estate transactions which utilizes a remotely accessible site on a computer network, for example a web site on the Internet, as a document transfer vehicle to facilitate the sharing of data, transfer of information and transfer of documents between a purchasers' lawyers and a vendors' lawyers in real estate transactions, including multi-unit real estate transactions such as a new condominium purchase. The system and method of the invention provides a cost efficient, time saving and environmentally friendly means of completing real estate transactions.

In the preferred embodiment the web site provides a browser-based, user friendly interface for the exchange of documentation between purchaser and vendor. Also, in the preferred embodiment the web site provides a generally accessible portion which allows a purchaser to retrieve general documentation relating to the real estate transaction generally, and a plurality of password-protected portions each of which can be accessed only by a purchaser's lawyer having a preset password and allows the purchaser's lawyer to retrieve purchaser-specific documentation relating particularly to the respective purchaser's unit. In the preferred embodiment the method and system of the invention also monitors when documents have been downloaded by each purchaser and flags the vendor's lawyer if any particular purchaser has not retrieved their documents by a preset time before the closing date.

The present invention thus provides a method for processing a real estate transaction, comprising the steps of a. creating a site on a computer network comprising a general portion and a restricted access portion comprising a plurality of pass phrase-protected components, associated with at least one data storage, b. allowing access to general documentation stored in the at least one data storage relating to a particular real estate transaction through the general portion, c. allowing access to purchaser-specific documentation stored in the at least one data storage relating to a particular purchaser through the pass-phrase protected component associated with the particular purchaser, d. providing each of a plurality of purchasers with a unique pass phrase, and e. in response to a request from the particular purchaser for documentation and entry of the pass phrase associated with the particular purchaser, transferring data, information, documents or any combination thereof from the at least one data storage to the purchaser.

In further aspects of the method of the invention: the data storage is accessed via a web site on the Internet; the method comprises the step of receiving from the particular purchaser and storing in the at least one data storage data or documentation or both; the documentation has been executed by the particular purchaser electronically; the restricted portion comprises a plurality of purchaser accessible pages each accessible to the particular purchaser upon entry of the particular purchaser's pass phrase; the web page comprises details of or access to products or services that may be associated with the transaction; the products or services include title insurance; the method further comprises the step of storing the documents in the data storage in a read only format; and/or the method further comprises the step of notifying the vendor if a purchaser has not downloaded documentation by a preset date.

The present invention further provides a system for processing a real estate transaction, comprising a server hosting a site on a computer network comprising a general portion and a restricted access portion comprising a plurality of pass phrase-protected components, and associated with at least one data storage, the site allowing access to general documentation stored in the at least one data storage relating to a particular real estate transaction through the general portion, and allowing access to purchaser-specific documentation stored in the at least one data storage relating to a particular purchaser through the pass-phrase protected component associated with the particular purchaser, and a computer in communication with the site, for entering a request from the particular purchaser for documentation, whereby upon entry of the pass phrase associated with the particular purchaser, the server transfers data, information, documents or any combination thereof from the at least one data storage to the computer.

In further aspects of the system of the invention: the site is a web site and the server is connected to the Internet; the restricted portion comprises a plurality of purchaser accessible web pages, each accessible to the particular purchaser upon entry of the particular purchaser's pass phrase; and/or the system further comprises means for notifying the vendor if a purchaser has not downloaded documentation by a preset date.

The present invention further provides a computer program product for use with a computer, the computer program product comprising a computer usable medium having computer readable program code means embodied in said medium for processing a real estate transaction, comprising a. computer readable program code means for creating a site on a computer network comprising a general portion and a restricted access portion comprising a plurality of pass phrase-protected components, associated with at least one data storage, b. computer readable program code means for allowing access to general documentation stored in the at least one data storage relating to a particular real estate transaction through the general portion, c. computer readable program code means for allowing access to purchaser-specific documentation stored in the at least one data storage relating to a particular purchaser through the pass-phrase protected component associated with the particular purchaser, d. computer readable program code means for providing each of a plurality of purchasers with a unique pass phrase, and e. computer readable program code means for, in response to a request from the particular purchaser for documentation and entry of the pass phrase associated with the particular purchaser, transferring data, information, documents or any combination thereof from the at least one data storage to the purchaser.

In further aspects of the computer program product, the data storage is accessed via a web site on the Internet; the computer program product comprises computer readable program code means for receiving from the particular purchaser and storing in the at least one data storage documentation that has been executed by the particular purchaser; the documentation has been executed electronically; the restricted portion comprises a plurality of purchaser accessible pages each accessible to a particular purchaser upon entry of the particular purchaser's pass phrase; the web page comprises details of or access to products or services that may be associated with the transaction; the products or services include title insurance; the computer program product further comprises computer readable program code means for storing the documents in the data storage in a read only format; and/or the computer program product further comprises computer readable program code means for indicating in a vendor interface that a purchaser has not downloaded documentation by a preset date.

### BRIEF DESCRIPTION OF THE DRAWINGS

In drawings which illustrate by way of example only a preferred embodiment of the invention,

FIG. 1 is a block diagram depicting various components in a preferred embodiment of the real estate processing system of the invention.

FIG. 2 is a flow chart showing the steps of a preferred embodiment of the method of the invention.

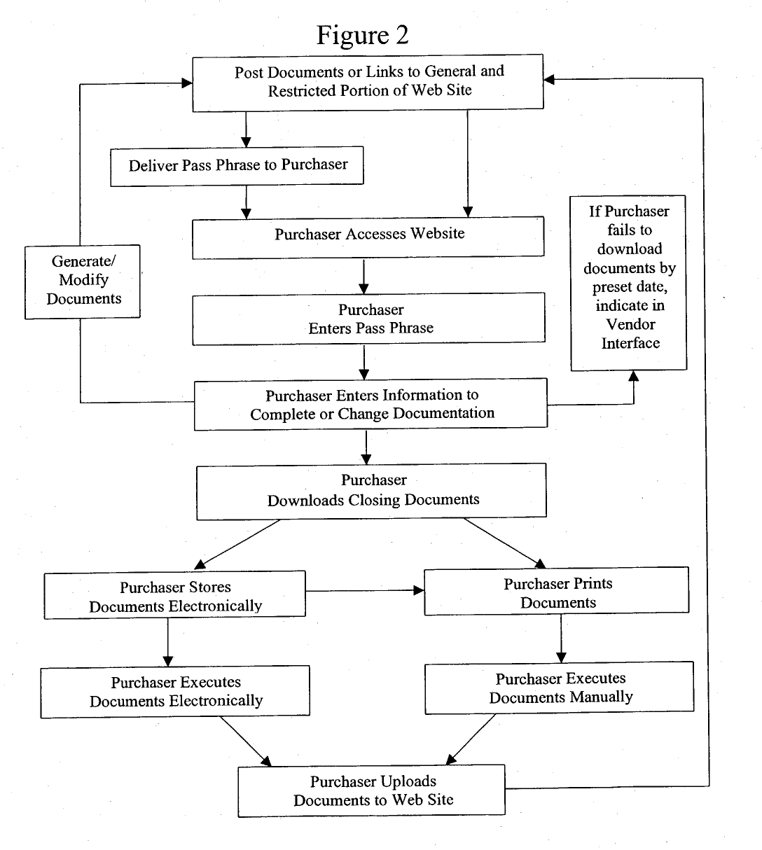

### DETAILED DESCRIPTION OF THE INVENTION

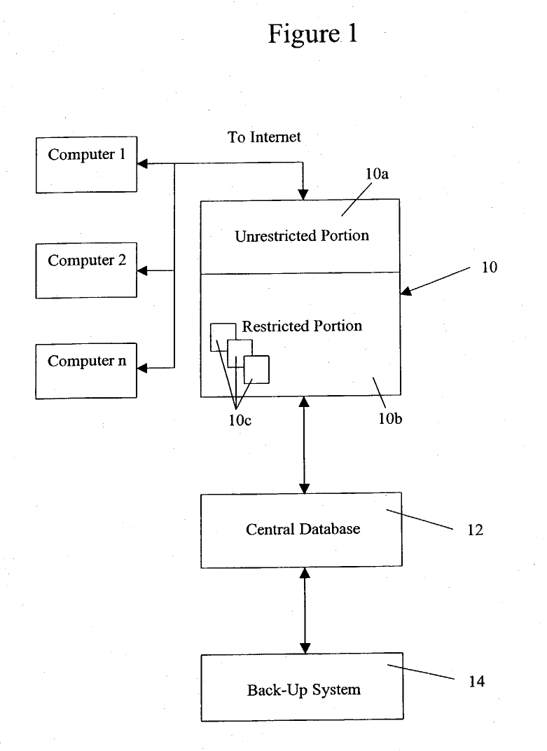

In accordance with a preferred embodiment of the invention and referring to FIG. 1, a remotely accessible site such as a web site 10 is created on a server, having a general portion 10a and a purchaser-specific, pass phrase-protected portion 10b. Preferably, the web site 10 will give the purchaser the option of secure or unrestricted data flow. The purchaser-specific portion 10b of the web site 10 is in turn parsed into a plurality of purchaser-accessible pages 10c, each accessible to a single purchaser (or a single lawyer or other representative, who may be acting on behalf of multiple purchasers), by inputting a unique pass phrase provided to each purchaser's lawyer by the vendor's lawyer. The general portion 10a may permit free access to anyone visiting the web site 10, or may be pass-phrase protected and accessible to each purchaser using their unique assigned pass phrase. The specific type of security and/or pass phrase system used to restrict access to the restricted portion 10b and optionally the general portion 10a of the web site 10 may be conventional and is a matter of selection, and the invention is not intended to be limited thereby. Further, whether or not the general portion 10a of the web site 10 is pass-phrase protected is a matter of selection and the preference of the system administrator.

The description of the invention will hereinafter refer to the selling party and all of its representatives as the “vendor,” and to the purchasing party and all of its representatives as the “purchaser.” It will be appreciated that the vendor and each purchaser is most likely represented by a lawyer or other real estate professional, and for purposes of simplicity references herein to the “vendor” or the “purchaser” are intended to include their respective lawyers and such other agents or representatives as may be involved in the transaction on their behalf.

It will also be appreciated that a lawyer or other representative (any of which may be referred to as an “agent”) may be acting on behalf of many purchasers, and in this case a single pass-phrase can be provided to the purchasers' agent, and in the purchaser-specific portion 10b of the web site 10 the agent will be given access to data and documentation specific to each of the purchasers on whose behalf the agent is acting. This can be provided as a summary or detailed listing on a single web page 10c, or on multiple web pages 10c, or otherwise as desired by the system administrator.

The web site 10 is associated with a central data storage, such as a database 12. Such database will contain all of the numerous documents necessary for the closing of a real estate transaction, which may include unrestricted documentation available to all purchasers, such as title advice memoranda, sample condominium documents (e.g. bylaws), drawings and plans, letters from blanket mortgage lenders etc.; and restricted, purchaser-specific documentation such as directions regarding title or the application of funds, statement of adjustments, undertakings, spousal consent forms, tax and rebate forms, for example. In the case of closing documents, the documents are preferably made available in a standard read-only format, such as a .pdf file or other popular formatted text file. However, it is possible to use any format which may be convenient to either party, with or without conversion to a standard format in the hands of the vendor or the purchaser. The web site 10 may provide links to readers and/or converters for different document formats to be downloaded by users of the site, and/or may be equipped to automatically convert documentation from the purchaser into the form desired by the vendor, or into a form requested by the purchaser.

While some of the documents and data contained in the database are not purchaser-specific and will be needed by all purchasers, other documents and data will be specific to the purchaser of a particular unit. Access to the purchaser-specific documents and data in the database 12 is controlled by providing each purchaser with a transaction-specific pass phrase that enables access to purchaser-specific documents in the database 12 corresponding to the particular purchaser only through a restricted access component dedicated to that particular purchaser, for example through a web page 10c set up for the particular purchaser, through which the closing documents necessary for completing the transaction in relation to the particular unit are retrieved from the database 12. In addition, the database 12 may store data collected from the purchaser, such as directions regarding title, and the web page 10b may provide details of and access (e.g. links) to other products and services that may optionally be associated with the transaction or the condominium unit itself, such as title insurance.

A back-up system 14 of a magnitude sufficient to maintain the integrity of the central database 12 is also preferably provided, to preserve the data and prevent service disruption in the event of failure of the server containing the central database 12.

In general, a purchaser is provided with a transaction-specific pass phrase through notification from the vendor by any convenient method of communication such as post, e-mail or facsimile transmission. The purchaser then accesses the web site 10, enters the designated pass phrase and downloads interim closing documentation and data, preferably in a common read only format such as .pdf. The purchaser may utilize a word processor such as WordPerfect (trademark) or Adobe Acrobat (trademark), or any other suitable application, to print the downloaded documents, or may store the documents and/or data electronically. The purchaser thus retrieves those interim closing documents which require the purchaser's signature. These documents can be executed using an electronic signature (where allowed by local law and approved by the parties to the transaction) or the documents can be manually executed and returned to the vendor by conventional means. In the preferred embodiment, the system is programmed to flag the vendor automatically or provide an indication in the vendor's administrative interface if the purchaser has not downloaded interim closing documentation or data by a preset date before the interim closing date.

With regard to the final closing date, the purchaser again accesses the web site 10, enters the designated pass phrase and downloads final closing documentation and data, preferably in a read only format such as .pdf. The purchaser may utilize a word processor such as WordPerfect (trademark) or Adobe Acrobat (trademark), or any other suitable application, to print the downloaded documents, or may store the documents and/or data electronically. The purchaser thus retrieves those final closing documents which require the purchaser's signature. These documents can be executed using an electronic signature (where allowed by local law and approved by the parties to the transaction) or the document can be manually executed and returned to the vendor by conventional means. Again, in the preferred embodiment, the system is programmed to flag the vendor automatically or provide an indication in the vendor's administrative interface if the purchaser has not downloaded final closing documentation or data by a preset date before the final closing date.

In the processing of both the interim and final closing documentation document management is provided by the system of the invention, and in the process an audit trail is established through the generation, processing and sharing of data and documentation which can be used to reconstruct the events occurring during the course of the transaction in the case of a breach or default by either the purchaser or the vendor.

In addition, a purchaser may order title insurance on line. According to this optional feature, a title insurance policy can be made available through the web site 10 which may be downloaded and printed or otherwise stored. The user may pay the premium for the title insurance via the web site 10 by credit card, account debit or other monetary transfer or settlement method.

The vendor, directly or through a third party application service provider (ASP), administers the database 12. In the initial stages of the transaction the vendor creates a file for each general document and a template for each purchaser-specific interim closing document, inputs all required data and then runs bulk document production, for example converting to a universally readable format such as .pdf (preferably read only to prevent tampering), for access through the web site 10. Interim closing documents are thus created and saved in an appropriate directory. Each restricted purchaser-specific web site portion or page is assigned a pass phrase, which is sent to the respective purchaser with an interim closing letter by conventional means such as post, e-mail, facsimile transmission or otherwise. Once the purchaser has satisfied any outstanding requirements, for example waiving conditions, providing deposit funds, providing mortgage information to the vendor's lending institution, etc., the vendor posts the purchaser-specific interim documentation and data or links thereto to the purchaser's page 10c in the restricted portion 10b of the web site 10 and the purchaser is then able to check the status of their purchaser-specific interim closing documentation, via a status report posted on the web page 10c and accessible to the purchaser's browser.

Through the same web page 10c, the purchaser uploads signed documentation, including any supporting documentation which may be scanned by the purchaser and added to the batch of closing documents, and can confirm the vendor's receipt of (electronically) signed and other interim closing documents and/or data uploaded to the website 10. All documents uploaded by the purchaser are preferably electronically date- and time-stamped upon receipt by the web site 10 to avoid disputes as to when documentation and/or data was delivered.

Prior to the final closing, the purchaser can input information, report changes in information or circumstances, etc., as well as upload directions regarding title information. The vendor enters the necessary data to complete all final closing documentation, and bulk documents are produced for posting or linking to the web site 10. Again, the status of document retrieval by the purchaser can be checked if needed. In the preferred embodiment, the system is programmed to flag the vendor automatically if any particular purchaser has not downloaded final closing documentation by a preset date before the final closing date.

An interested third party can be provided with a third party interface enabling it to intervene in the transaction. For example, a mortgagee can access the third party interface and upload specific conditions that must be satisfied by a purchaser or its representatives before mortgage monies will be advanced. The vendor is thus immediately put on notice of the requirements which will have to be met by the purchaser in order to enable the purchaser to obtain funds for closing.

The vendor may at any time generate a report showing the status of the purchasers' retrieval and execution of closing documentation. In any case where a particular purchaser is not meeting deadlines or otherwise moving the transaction forward in a timely fashion, the vendor can withhold (or change) the pass phrase for that particular purchaser's web page 10c, or delay the posting or linking of documents to the web page 10c, pending the purchaser's satisfaction of outstanding requirements.

Status indicators at closing may be accessed by third parties to expedite the completion of closing. For example, a conveyancer may enter confirmation that the closing documentation has been registered, triggering an indicator which instructs the vendor's lawyer or other agent viewing the administrative interface at a completely different location such as his or her office, or even the sales agent at the project office, to release the keys to the purchaser.

Many different interfaces are thus available according to the invention, each of which displays only as much information as the system administrator will allow in any particular case. The vendor's interface, which may be the same interface used by the vendor's lawyer, can display any information requested by the vendor or its representatives; the purchaser's interface, which may optionally be accessed by both the purchaser's lawyer and the purchaser (allowing purchasers to track the progress of the transaction without having to rely on their lawyers for updates), displays general unrestricted information and purchaser-specific information only to the extent that it is relevant to the particular purchaser; the sales agent's interface keeps the sales agent up to date on the status of transfer of possession of the units; a superintendent's interface may keep the building custodian up to date on the status of transfer of possession of the units; a lender's interface allows for tracking and intervention by third party lenders; and if the system is operated by an application service provider (ASP), an ASP interface may provide access to all transactions occurring in the system, historical records, etc. These are examples of available interfaces, and other interfaces may be created as desired by the system administrator.

The method and system of the invention thus allow a vendor greater control over the processes involved in a multi-unit real estate transaction, at considerably lower cost and with a significantly lower administrative burden than is presently experienced in the distribution of paper documentation. The invention facilitates not only dissemination of data on a purchaser-specific basis, but also the collection of data such as directions regarding title information. The invention also provides for automatic verification of documentation and data delivery, thus avoiding disputes regarding the delivery and receipt of documents and potentially saving the vendor significant legal costs.

Various embodiments of the present invention having been thus described in detail by way of example, it will be apparent to those skilled in the art that variations and modifications may be made without departing from the invention. The invention includes all such variations and modifications as fall within the scope of the appended claims.

We claim:

1. A method for processing a real estate transaction, comprising the steps of
a. creating a site on a computer network comprising a general portion and a restricted access portion comprising a plurality of pass phrase-protected components, associated with at least one data storage,
b. allowing access to general documentation stored in the at least one data storage relating to a particular real estate transaction through the general portion,
c. allowing access to purchaser-specific documentation stored in the at least one data storage relating to a particular purchaser through the pass-phrase protected component associated with the particular purchaser,
d. providing each of a plurality of purchasers with a unique pass phrase, and
e. in response to a request from the particular purchaser for documentation and entry of the pass phrase associated with the particular purchaser, transferring data, information, documents or any combination thereof from the at least one data storage to the purchaser.

2. The method of claim 1 wherein the data storage is accessed via a web site on the Internet.

3. The method of claim 2 further comprising the step of receiving from the particular purchaser and storing in the at least one data storage data or documentation or both.

4. The method of claim 3 wherein the documentation has been executed by the particular purchaser electronically.

5. The method of claim 2 wherein the restricted portion comprises a plurality of purchaser accessible pages each accessible to the particular purchaser upon entry of the particular purchaser's pass phrase.

6. The method of claim 2 wherein the web page comprises details of or access to products or services that may be associated with the transaction.

7. The method of claim 6 wherein the products or services include title insurance.

8. The method of claim 2 comprising the step of storing the documents in the data storage in a read only format.

9. The method of claim 2 further comprising the step of notifying the vendor if a purchaser has not downloaded documentation by a preset date.

10. A system for processing a real estate transaction, comprising
a server hosting a site on a computer network comprising a general portion and a restricted access portion comprising a plurality of pass phrase-protected components, and associated with at least one data storage,
the site allowing access to general documentation stored in the at least one data storage relating to a particular real estate transaction through the general portion, and allowing access to purchaser-specific documentation stored in the at least one data storage relating to a particular purchaser through the pass-phrase protected component associated with the particular purchaser, and
a computer in communication with the site, for entering a request from the particular purchaser for documentation,
whereby upon entry of the pass phrase associated with the particular purchaser, the server transfers data, information, documents or any combination thereof from the at least one data storage to the computer.

11. The system of claim 10 wherein the site is a web site and the server is connected to the Internet.

12. The system of claim 11 wherein the restricted portion comprises a plurality of purchaser accessible web pages, each accessible to the particular purchaser upon entry of the particular purchaser's pass phrase.

13. The system of claim 10 further comprising means for notifying the vendor if a purchaser has not downloaded documentation by a preset date.

14. A computer program product for use with a computer, the computer program product comprising a computer usable medium having computer readable program code means embodied in said medium for processing a real estate transaction, comprising
a. computer readable program code means for creating a site on a computer network comprising a general portion and a restricted access portion comprising a plurality of pass phrase-protected components, associated with at least one data storage,
b. computer readable program code means for allowing access to general documentation stored in the at least one data storage relating to a particular real estate transaction through the general portion,
c. computer readable program code means for allowing access to purchaser-specific documentation stored in the at least one data storage relating to a particular purchaser through the pass-phrase protected component associated with the particular purchaser,
d. computer readable program code means for providing each of a plurality of purchasers with a unique pass phrase, and
e. computer readable program code means for, in response to a request from the particular purchaser for documentation and entry of the pass phrase associated with the particular purchaser, transferring data, information, documents or any combination thereof from the at least one data storage to the purchaser.

15. The computer program product of claim 14 wherein the data storage is accessed via a web site on the Internet.

16. The computer program product of claim 15 further comprising computer readable program code means for receiving from the particular purchaser and storing in the at least one data storage documentation that has been executed by the particular purchaser.

17. The computer program product of claim 16 wherein the documentation has been executed electronically.

18. The computer program product of claim 15 wherein the restricted portion comprises a plurality of purchaser accessible pages each accessible to a particular purchaser upon entry of the particular purchaser's pass phrase.

19. The computer program product of claim 15 wherein the web page comprises details of or access to products or services that may be associated with the transaction.

20. The computer program product of claim 19 wherein the products or services include title insurance.

21. The computer program product of claim 15 comprising computer readable program code means for storing the documents in the data storage in a read only format.

22. The computer program product of claim 15 further comprising computer readable program code means for indicating in a vendor interface that a purchaser has not downloaded documentation by a preset date.
